(19) United States
(12) Patent Application Publication
(10) Pub. No.: US 2012/0023983 A1
(43) Pub. Date: Feb. 2, 2012

(54) REMOVABLE REFRIGERATION UNIT

(75) Inventor: Nick G. Glaros, Boca Raton, FL (US)

(73) Assignee: SG BEVERAGE SOLUTIONS, INC., Fort Lauderdale, FL (US)

(21) Appl. No.: 13/192,156

(22) Filed: Jul. 27, 2011

Related U.S. Application Data
(60) Provisional application No. 61/369,906, filed on Aug. 2, 2010.

(51) Int. Cl. A47F 3/04; B23P 15/26; F25B 49/00

(52) U.S. Cl. 62/125; 62/255; 29/890.035

(57) ABSTRACT

A merchandiser cooler is provided for chilling and/or freezing food and beverage containers. To facilitate service and/or repair of the cooler, the merchandiser cooler includes numerous refrigeration components that are divided between a removable refrigeration unit and permanent placement within a cabinet of the merchandiser cooler. The refrigeration components may be fluidly connected in a manner that allows for quick and efficient release such that the removable refrigeration unit may be easily removed and/or replaced by a single individual who lacks specialized training.

### CROSS-REFERENCE TO RELATED APPLICATIONS

This application claims priority under 35 U.S.C. §119 to U.S. Provisional Patent Application No. 61/369,906, entitled “Removable Refrigeration Unit,” filed Aug. 2, 2010, the contents of which are incorporated by reference as if set forth herein in full.

### FIELD

The present invention relates in general to food and beverage coolers and, in particular, to refrigeration units that may be conveniently and rapidly removed from their associated coolers for repair and/or replacement.

### BACKGROUND

Commercial merchandiser or showcase coolers and/or freezers (hereinafter “merchandiser coolers”) are used to chill beverages such as soda, juice, water, energy drinks, and beer or other alcoholic beverages prior to sale. They are also used to chill or freeze cold snacks such as yogurt and ice cream. Merchandiser coolers generally allow customers to view cooler contents without the need to open doors and are often found in grocery and convenience stores.

Merchandiser coolers generally feature a refrigeration unit at the bottom of the cooler's cooled merchandise compartment. In servicing merchandiser coolers, there are times when one or more components of or the complete refrigeration unit must be accessed for repair and/or replacement. To avoid inconvenient and time-consuming on-site repair operations that often render the cooler inoperable for a period of time, and to avoid the need to cut, refit, and recharge refrigerant tubing with each service, some refrigeration units have been modularized to form removable refrigeration cartridges. These cartridges may be disconnected and removed from the merchandiser cooler for remote repair and generally incorporate all cooling components (e.g., a compressor, an evaporator, a condenser, one or more fans, ductwork to route cool and warm air to and from the refrigerated compartment, and insulation used to separate the evaporative cooling components from the condenser and/or the compressor). Such removable cartridges mate with corresponding ductwork within a cabinet of the merchandiser cooler to route warm return air and cold air to and from the refrigeration cartridge.

While the removable cartridges are an improvement over system-integrated refrigeration units that cannot be removed, the cartridges are excessively cumbersome and heavy, often weighing in excess of 70 pounds. Indeed, the cartridges are so weighty that, in some states, labor union regulations mandate that two individuals maneuver the cartridges, offsetting the usefulness and the practicality of the cartridge designs.

In addition, because the cartridges include both cooling components (e.g., an evaporator) and heat generating components (e.g., a condenser) that are necessary to complete the refrigeration cycle, access to the components—even after the cartridge is removed—is difficult because of the ductwork and insulation necessary to separate the cooling and heat generating components coexisting within the cartridge. In many cases, the cartridges must be disassembled after being removed from the cooler to gain access to the components in need of service and/or repair. Moreover, current removable cartridges rely on sealing gaskets to mate the ductwork of the cartridges with the ductwork maintained within the coolers, increasing the possibility of air leakage and reducing system efficiency.

### SUMMARY

The present invention relates to refrigeration systems for merchandiser coolers for chilling and/or freezing food and beverages. The inventors have recognized the need for an accessible, lightweight, and compact removable refrigeration unit for merchandiser coolers. The inventors have also recognized that such a removable refrigeration unit may be achieved through a design that includes only a portion of the refrigeration components needed to cool an interior cooling compartment of the merchandiser cooler, or to remove heat from warm air circulating from the cooling compartment of the merchandiser cooler.

Specifically, the inventors have recognized numerous advantages associated with positioning the heat-generating components of a refrigeration system (e.g., the condenser, the compressor) within the removable refrigeration unit while leaving the cooling components (e.g., the evaporator) as well as the requisite ductwork and insulation elements within a cabinet of the merchandiser cooler, allowing the refrigeration components contained within the removable refrigeration unit to work in conjunction with the refrigeration, ventilation, and insulation components that are permanently integrated within a cabinet of the cooler. First, the unit is lightweight. Thus, it may be safely and comfortably transported by a single individual and may be shipped through traditional package shipping channels such as UPS and FedEx. The removable refrigeration unit is also compact, further increasing the unit's portability. In addition, because the removable refrigeration unit is not overly crowded with all of the necessary refrigeration components, ductwork, and insulation elements, the refrigeration components contained within the unit are easily accessible for repair and/or replacement without the need to disassemble the unit prior to repair.

In particular, a first aspect of the present invention involves a merchandiser cooler. The merchandiser cooler includes a cabinet that frames a cooling compartment, a removable tray that is coupled with the cabinet, and a number of cooling components that work together to cool the cooling compartment. The cooling components include insulation components for insulating the cooling compartment, ventilation components for circulating air to and from the cooling compartment, and refrigeration components for removing heat from air circulating from the cooling component. The refrigeration components are divided into a first group of refrigeration components disposed upon the removable tray, and a second group of refrigeration components affixed within the cabinet.

The refrigeration components may include a compressor, a condenser, an expansion valve, an evaporator, a condenser fan, and control electronics. While all of the insulation and ventilation components (e.g., insulation elements, recirculation fans, air ducts) remain affixed within the cabinet, the refrigeration components may be apportioned between the first group of refrigeration components that are disposed upon the removable tray and the second group of components that are affixed within the cabinet. The first and second groups of refrigeration components may be apportioned in any appropriate manner. For example, the first group of refrigeration components may include the compressor and the condenser. In another embodiment, the first group of refrigeration components may also include the condenser fan and the control electronics. The second group of refrigeration components may include the evaporator.

In one implementation, the merchandiser cooler may include a quick disconnect system for separating a refrigeration line that fluidly connects the first and second groups of refrigeration components. The quick disconnect system may incorporate one or more quick-disconnect couplings or fittings that may be used to selectively couple and decouple the refrigeration line substantially without fluid loss or air intake. The quick-disconnect couplings may be custom or off-the-shelf connectors of any appropriate size, shape, type, and/or configuration.

The merchandiser cooler may also include a diagnostic computer for determining and reporting on an operational health of the cooler. In addition, the diagnostic computer or another appropriate module may be communicatively linked with a remote cooler tracking system that tracks and/or reports other operational or statistical information relating to the cooler or the removable refrigeration unit including, for example, product inventory levels, a location of the cooler and/or the removable refrigeration unit, the operational health of the cooler (e.g., coolant charge, leakage), and more.

A second aspect of the present invention is directed to a removable refrigeration unit for a merchandiser cooler having a cabinet with affixed insulation components for insulating a cooling compartment within the cabinet (e.g., insulation elements) and affixed ventilation components for circulating air to and from the cooling compartment (e.g., recirculation fans, air ducts). The removable refrigeration unit includes a tray for slidably coupling with the cabinet of the merchandiser cooler, as well as a first group of refrigeration components that are disposed upon the tray. One or more of the first group of refrigeration components detachably interconnect with one or more of a second group of refrigeration components that are affixed within the cabinet such that the tray and the first group of refrigeration components are removable from the cabinet.

While excluding an evaporator, the first group of refrigeration components may include any of a compressor, a condenser, a condenser fan, an expansion valve, and control electronics. All or a portion of the first group of refrigeration components may be in fluid communication with the evaporator that is affixed within the cabinet of the cooler. In this regard, the removable refrigeration unit may include a fluid line that detachably interconnects the first group of refrigeration components and the second group of refrigeration components. One or more connector pairs may detachably join the fluid line between the first and second groups of refrigeration components such that the fluid line may be separated or broken to allow the first group of refrigeration components to be removed from the cooler on the slidable tray. Each connector pair may be selectively moved between connected and disconnected positions, where there is substantially no fluid leakage in the fluid line in the connected position, the disconnected position, or in the transition between the connected and disconnected positions.

Yet another aspect of the present invention is directed to a method of replacing a removable refrigeration unit for a merchandiser cooler having a cabinet. The method involves releasing one or more connectors that join a refrigeration line circulating fluid between first and second groups of refrigeration components that are collectively configured to remove heat from air circulating from a cooling compartment of the merchandiser cooler. The first group of refrigeration components includes components that are associated with the removable refrigeration unit and the second group of refrigeration components includes components that are affixed within the cabinet of the merchandiser cooler. After the connectors are released, the removable refrigeration unit is slid manually from the cabinet.

### BRIEF DESCRIPTION OF THE DRAWINGS

For a more complete understanding of the present invention and further advantages thereof, reference is now made to the following detailed description, taken in conjunction with the drawings, in which:

FIG. 1 illustrates a front perspective view of one embodiment of a merchandiser cooler having a removable refrigeration unit;

FIG. 2 illustrates a front perspective view of the merchandiser cooler of FIG. 1, where the removable refrigeration unit is partially removed from the merchandiser cooler;

FIG. 3 illustrates a front perspective view of the removable refrigeration unit of FIG. 1;

FIG. 4 illustrates a top plan view of the removable refrigeration unit of FIG. 1;

FIG. 5 illustrates a side plan view of the removable refrigeration unit of FIG. 1;

FIG. 6 illustrates a partial perspective view of a frame of the merchandiser cooler of FIG. 1;

FIG. 7 illustrates two male connectors that splice a fluid line of a refrigeration system of the removable refrigeration unit of FIG. 1;

FIG. 8 illustrates two female connectors that correspond to the male connectors of FIG. 7; and

FIG. 9 illustrates a functional block diagram that demonstrates the merchandiser cooler of FIG. 1 in communication with a remote cooler tracking system.

### DETAILED DESCRIPTION

The following description describes exemplary embodiments of a merchandiser cooler for chilling and/or freezing food and beverage containers. Specifically, the inventors have recognized a need for a removable refrigeration unit that is lightweight and reasonably manipulated by one person such that a single individual may quickly and conveniently remove and/or replace the refrigeration unit, causing minimum downtime. Further, the inventors have recognized the need for a removable refrigeration unit that offers ready access to the components contained within the removable refrigeration unit to facilitate efficient repairs.

In this regard, the description details embodiments of a merchandiser cooler that features a lightweight, removable refrigeration unit that a single individual may quickly and conveniently release and remove from the merchandiser cooler and either carry away for remote repair or perform time-efficient repairs on-site. That is, a refrigeration unit in need of service or repairs may be all or partially removed from a cabinet of the merchandiser cooler to ease access for repair or to immediately exchange the dysfunctional unit for an operational unit, avoiding time-consuming and inconvenient on-site service that decommissions the merchandiser cooler for an unacceptable period of time. The removable refrigeration unit may be safely maneuvered and carried by a single person with no specialized training.

In addition, the refrigeration unit allows ready access to the refrigeration components within the unit and is designed to decouple from the cabinet of the merchandiser cooler with minimal hassle, little or no fluid leakage, and without introducing air into the coolant line. As a result, rather than a skilled refrigeration technician, the cooler owner or lessee, a route driver that delivers and fills the cooler with product, or another individual that lacks specialized training and/or tools may successfully swap out a refrigeration unit in need of repair or, alternatively, perform time-efficient on-site repairs. For example, a route driver that normally replenishes the cooler with product may simply replace a malfunctioning removable refrigeration unit during a routine visit to restock cooler inventory. In another example, the cooler owner or lessee may mail-order a replacement refrigeration unit, install the replacement unit, and return the broken unit to the manufacturer for repair. Because the removable refrigeration unit is significantly lighter than existing cartridge-type units, it may be sent through traditional package channels such as UPS and FedEx, which is much faster and less expensive than shipping heavier units via truck freight lines. The following description should be understood as exemplifying one or more embodiments of the merchandiser cooler and removable refrigeration unit and is not limited to these exemplary embodiments.

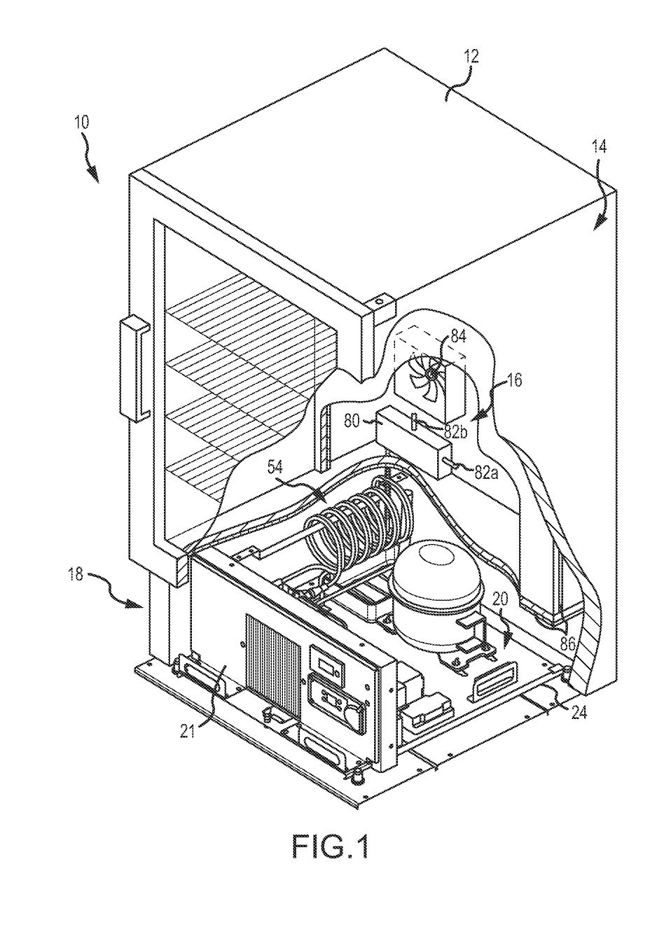

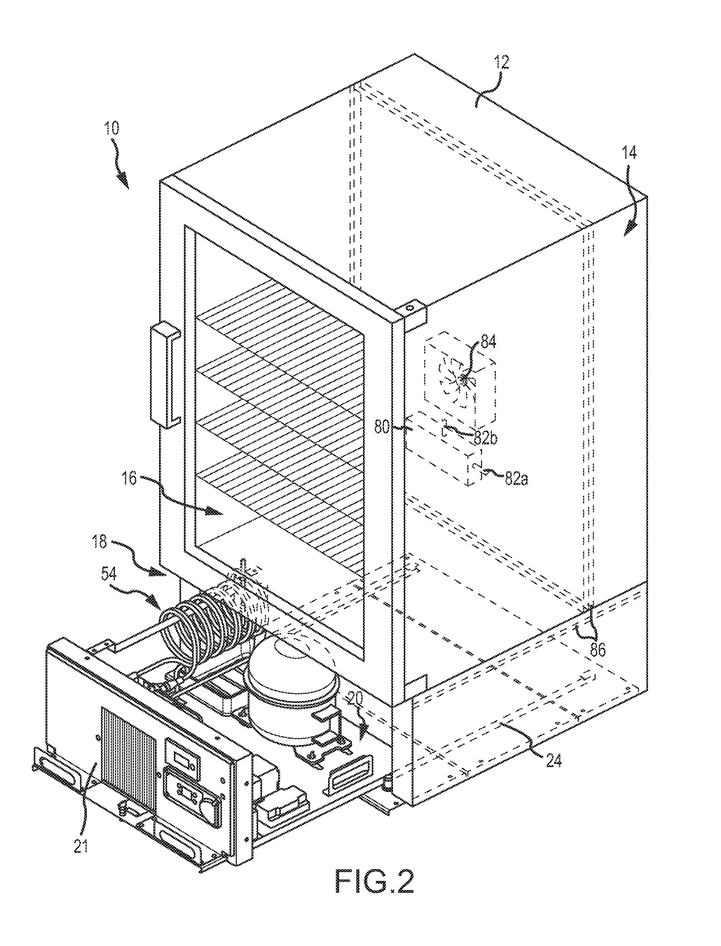

FIGS. 1 and 2 illustrate an exemplary embodiment of a merchandiser cooler 10 having a removable refrigeration unit 20. FIG. 1 shows the removable refrigeration unit 20 in a fully installed position, while FIG. 2 shows the removable refrigeration unit 20 in a partially removed position. In this embodiment, the merchandiser cooler 10 includes a cabinet 12 having a top portion 14 and a bottom portion 18. The top portion 14 of the cabinet 12 forms a cooling compartment 16 for housing food and beverage containers (not shown) to be cooled by the merchandiser cooler 10. The bottom portion 18 of the cabinet 12 is configured to slidably couple with the removable refrigeration unit 20. That is, in this embodiment, the removable refrigeration unit 20 may slide into and out of the bottom portion 18 of the cabinet 12 along angle brackets 24 within the bottom portion 18 of the cabinet 12. A front panel 21 may overlay the removable refrigeration unit 10 for aesthetic and/or ventilation purposes. The front panel may include a grill (not shown) or any other appropriate and/or desirable features that facilitate airflow, protect electronic and/or cooling components, and so on.

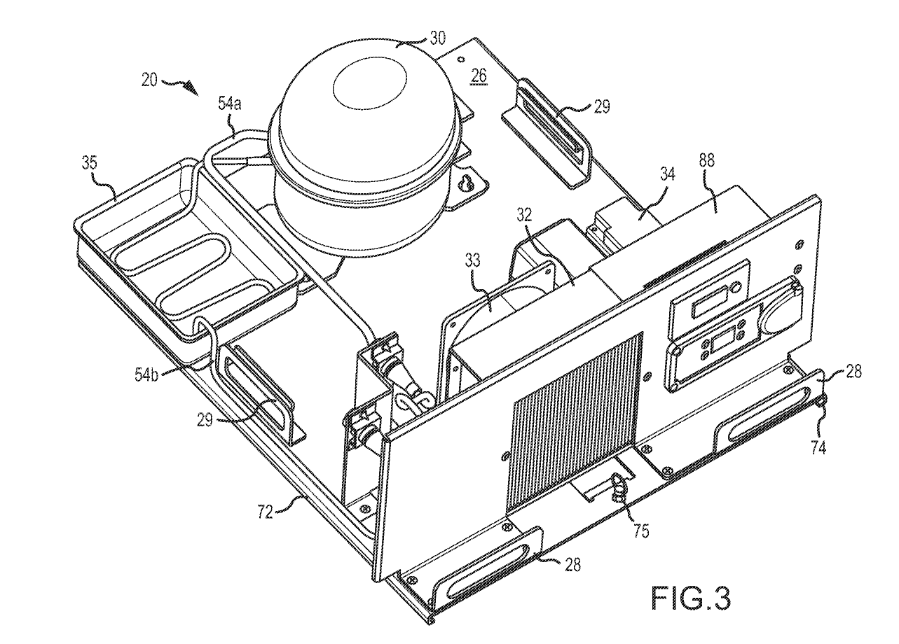

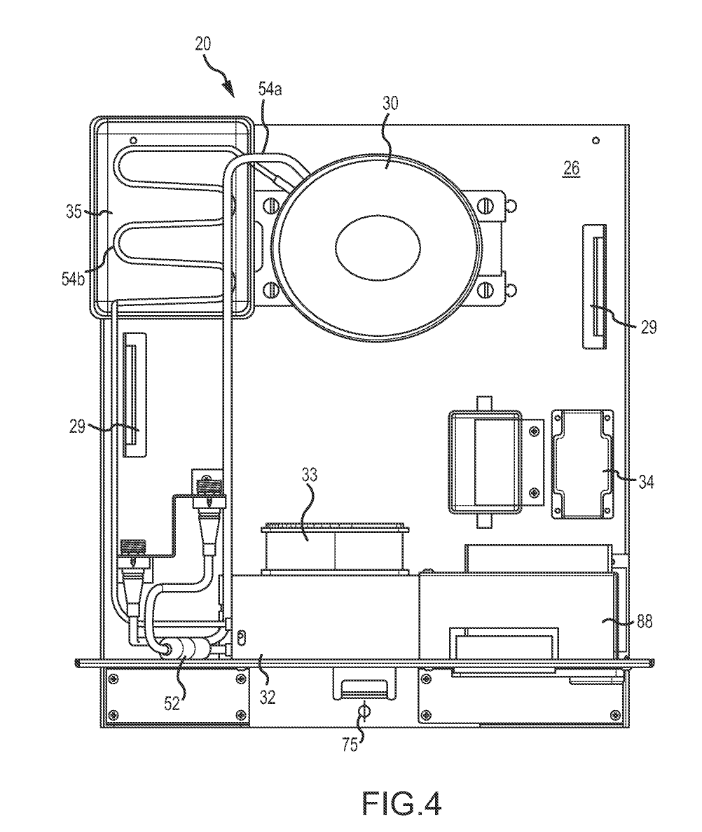

FIGS. 3 and 4 illustrate front perspective and top plan views of one embodiment of the removable refrigeration unit 20, respectively. In this implementation, the removable refrigeration unit 20 includes a pull-out tray 26. Left and right edges 72, 74 of the pull-out tray 26 may be configured as appropriate (e.g., rounded, folded, etc.) to mate with the angle brackets 24 within the bottom portion 18 of the cabinet 12 (FIGS. 1-2). The pull-out tray 26 may also include a first set of handles 28 to assist in pulling the removable refrigeration unit 20 from and pushing the removable refrigeration unit 20 into the cabinet 12 (FIGS. 1-2) for repair and/or replacement. A second pair of handles 29 may extend from a rear portion of the pull-out tray 26 to assist in transporting the removable refrigeration unit 20 offsite.

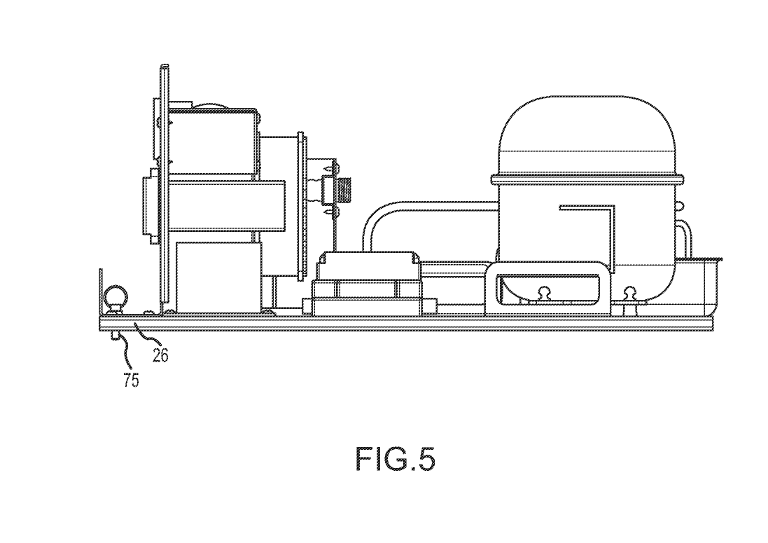

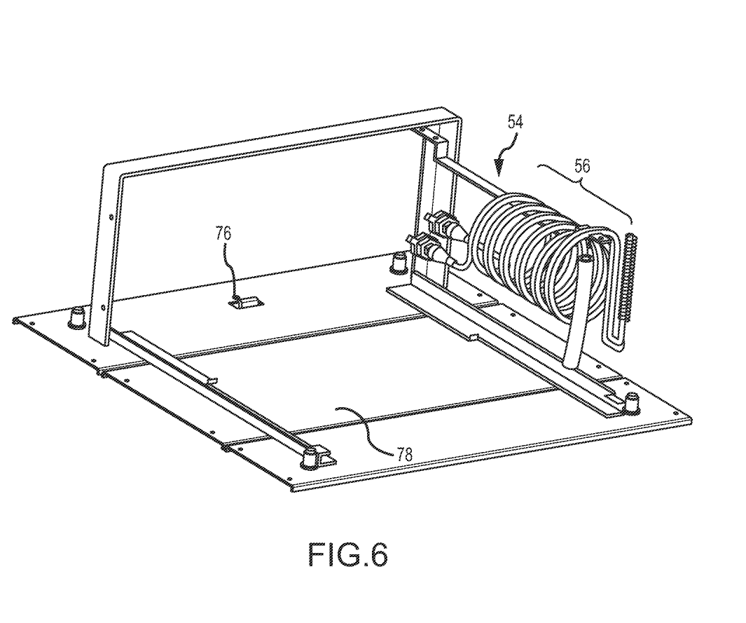

To secure the tray 26 in place when installed within the cabinet 12, the removable refrigeration unit 20 may include an appropriate locking feature. In one example shown in FIGS. 4-6, the locking feature may include a spring plunger lock 75 (FIGS. 3-5) that protrudes through the pull-out tray 26 (FIGS. 4-5) and extends into a mating aperture 76 (FIG. 6) within a base 78 of the cooler cabinet 12. The cabinet 12, the tray 26, the angle brackets 24, and the front panel 21 may be formed of any appropriate material or combination of materials including metals such as aluminum and/or steel.

To streamline and decrease the weight of the removable refrigeration unit 20 such that it may be maneuvered by one person, the components used to cool the cooling compartment 16 may be divided into two groups. A first group of refrigeration components may be disposed upon the pull-out tray 26 such that they are part of the removable refrigeration unit 20 and are removed from the merchandiser cooler 10 when the tray 26 is slid from the bottom portion 18 of the cabinet 12, as discussed above. A second group of refrigeration components may remain permanently integrated or affixed within the cabinet 12 such that they remain within the cabinet 12 when the refrigeration unit 20 is removed.

Returning to the embodiment shown in FIGS. 3-4, the first group of refrigeration components may include a compressor 30, drip tray 35, a condenser 32, a condenser fan 33, a line drier/expansion valve 52 (FIG. 4), and an electrical control unit/relay box 34. As discussed above, these components may reside on the pull-out tray 26 and may be removed from the cabinet 12 as part of the removable refrigeration unit 20 once disconnected from the second group of refrigeration components that are integrated into and remain within the cooler 10. The pull-out tray 26 may also include an electrical quick connect panel 88 that is configured to connect with power supplied by a conventional wall outlet or another suitable power source upon installation of the removable refrigeration unit 20.

As shown in FIGS. 1-2, the second group of refrigeration components includes components that remain integrated within the body of the cooler 10 and may include an evaporator 80. The cabinet 12 may also incorporate ducts 82a-b for providing an air intake from the cooling compartment 16 and an output to the cooling compartment 16, respectively, and one or more recirculation fans 84 for circulating air to, from, and about the cooling compartment 16. Moreover, the cabinet 12 may incorporate a number of insulation elements 86 for thermally shielding the cooling compartment 16. The evaporator 80, ducts 82a-b, recirculation fans 84, and insulation elements 86 may have any appropriate size, shape, type and/or configuration to accommodate the physical constraints of the cabinet 12, the internal cooling compartment 16, and/or the removable refrigeration unit 20. For example, these components may be positioned between the removable refrigeration unit 20 and the cooling compartment 16 or they may be at the rear of both of the removable refrigeration unit 20 and the cooling compartment 16. That is, these elements may be positioned in any appropriate configuration to allow for cooperation with the first group of refrigeration components on the pull-out tray 26 and the internal cooling compartment 16.

The second group of refrigeration components, the ventilation components, and the insulation components are suited to remain within the cabinet 12 because, unlike the first group of refrigeration components disposed on the pull-out tray 26, they rarely experience operational failures and if they do fail, they are comparatively easy to repair or replace via direct access through the cabinet 12 (i.e., they do not require a great deal of time and/or skill to replace on-site).

Notably, any appropriate combination of components may be distributed across the first and second groups of cooling components. For example, while the expansion valve/line drier 52 is described above as being incorporated into the first group of components within the removable refrigeration unit 20, the expansion valve may reside within the cabinet 12 or within the removable refrigeration unit 20 as appropriate.

When the removable refrigeration unit 20 is installed within the cabinet 12, the first and second groups of refrigeration components are situated as appropriate to carry out a vapor compression refrigeration cycle. In one exemplary implementation, a circulating refrigerant such as, for example, R134A or pressurized carbon dioxide (CO₂) may enter the compressor 30 as a vapor through a low pressure portion 54a of a fluid line 54. The vapor is compressed in the compressor 30 and superheated vapor travels across the drip tray 35 through a high pressure portion 54b of the fluid line 54 to the condenser 32, which first cools and removes the superheat and then condenses the vapor into a liquid by removing additional heat at constant pressure and temperature. The liquid refrigerant continues through the high pressure portion 54b of the fluid line 54 to the expansion valve/line drier 52 where its pressure abruptly decreases, causing flash evaporation and auto-refrigeration of some of the liquid refrigerant. The resulting mixture of liquid and vapor at a lower temperature and pressure travels through a series of coils 56 (FIG. 6) in the high pressure portion 54b of the fluid line 54 from the expansion valve 52 to the evaporator 80 within the cabinet 12, where it is completely vaporized by warm air from the cooling compartment 16 being blown by the recirculation fans 84 across the evaporator coils and/or tubes of the evaporator 80. The resulting refrigerant vapor then returns to the compressor 30 through the low pressure portion 54a of the fluid line 54.

By splitting the refrigeration system into groups of components that remain within the cooler cabinet 12 and that are modularized and removable from the cabinet 12 as part of the removable refrigeration unit 20, the weight of the removable refrigeration 20 may be reduced by approximately 50%. In addition, as described above, this dual configuration allows the removable refrigeration unit 20 to work in conjunction with the ductwork and insulation that is conventionally maintained within the cabinet 12, and therefore, the removable refrigeration unit 20 does not include or require additional ductwork (e.g., ducts 82a-b) and/or insulation (e.g., insulation elements 86) to separate cooled and heated sections of the removable refrigeration unit 20. There is also no need to break and seal ductwork between the removable refrigeration unit 20 and the cabinet 12 when the unit 20 is removed and installed, eliminating the possibility of air leaks at these seals (e.g., gaskets) and improving system efficiency. The lack of ductwork and insulation on the removable refrigeration unit 20 results in a much simpler unit design that provides convenient access to all of the components within the unit 20 (e.g., the compressor 30, the condenser 32, the electrical control unit 34) such that the components may be replaced or repaired without the need to disassemble the refrigeration unit 20, thereby decreasing the time required for service.

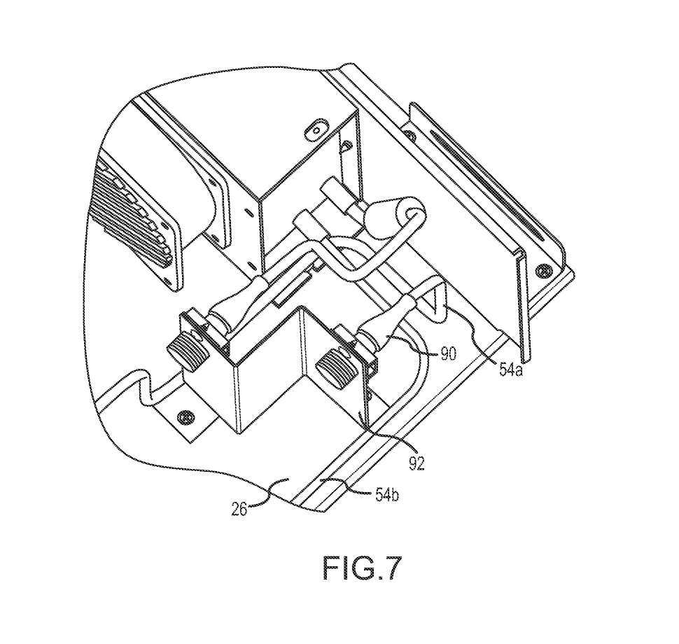

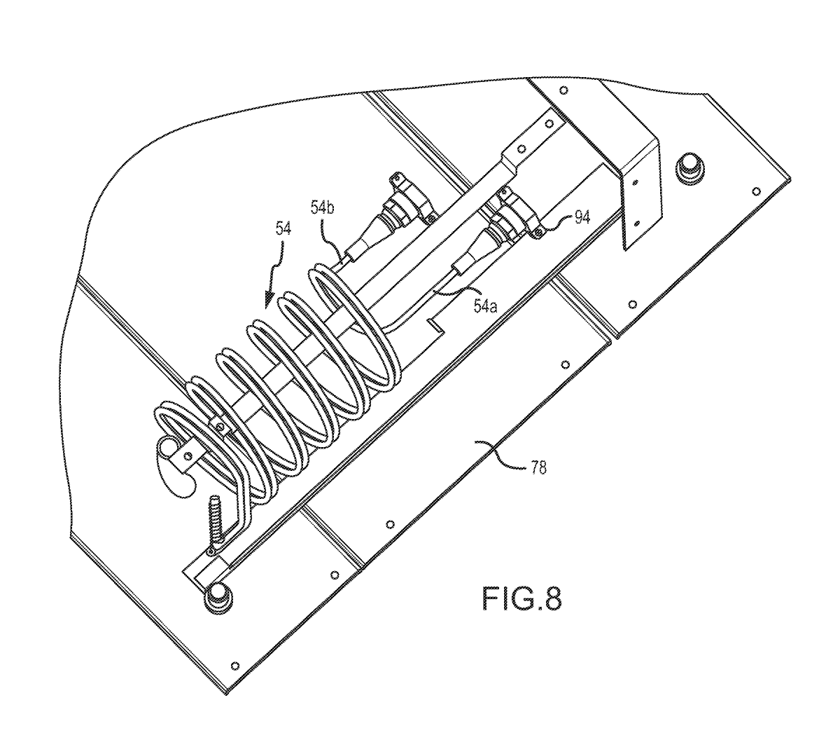

To make this type of split refrigeration system possible, the fluid line 54 must be broken without causing fluid loss or leakage from the fluid line 54 and without introducing air into the fluid line 54. That is, a user such as a store owner, clerk, or repair person must be able to move the fluid line between connected and disconnected positions quickly, efficiently, without specialized or even commonly-used tools, and without negatively impacting the functionality of the refrigeration system. In this regard, FIGS. 7 and 8 detail an exemplary disconnect assembly that includes quick-disconnect hardware for selectively separating the refrigeration line 54 between the evaporator 80 and the expansion valve/line drier 52 and between the evaporator 80 and the condenser 32.

Specifically, each junction in the fluid line 54 may include a male coupling 90 (FIG. 7). In one embodiment, the male coupling 90 may be affixed to and supported by a bracket 92 that protrudes from the pull-out tray 26. The male coupling 90 may be selectively mated with a corresponding female coupling 94 (FIG. 8). To separate the fluid line 54, a user may manually engage and disengage the male and female couplings 90, 94. The couplings 90, 94 may be off-the-shelf or custom quick-disconnect couplings and may have any appropriate size, shape, type, and/or configuration capable of retaining the refrigerant within the fluid line 54 when in connected and disconnected positions and that allow little or no fluid loss or air inclusion when moving between the connected and disconnected positions. In one embodiment, the couplings may be Parker Series 5500 self-sealing brass couplings (e.g., male coupling 5502-04B-06, female coupling 5505-04B-06).

Once separated, the evaporator 80 is physically divided from the remainder of the refrigeration system, and a single individual may manually slide the unit 20 from the bottom portion 18 of the cabinet 12 and carry it away. To accommodate a partial removal of the refrigeration unit 20, as shown in FIG. 2, the tubing coils 56 of the fluid line 54 may contract and expand as the pull-out tray 26 slides into and out of the bottom portion 18 of the cabinet 12 within the brackets 24. This allows the removable refrigeration unit 20 to be partially, but not fully, removed within the need to break the fluid line 54.

To prevent damage to the unit (e.g., overextending copper tubing, damage to wiring, etc.) upon the removal or installation of the removable refrigeration unit 20, the unit 20 may incorporate a positive stop (not shown) into the travel of the pull-out tray 26 or any other appropriate component of the removable refrigeration unit 20. That is, the unit 20 may incorporate a positive stop at which the couplings 90, 94 and the electrical quick connect panel 88 are disconnected/connected upon the removal/installation of the unit 20. The positive stop may have any appropriate configuration and/or location that serves to prevent the unit 20 from being over-extended when the fluid line 54 and the electrical connections are in a connected state or under-extended when the fluid line 54 and the electrical connections are in a disconnected state.

Because the removable refrigeration unit 20 does not include the evaporator 80, ductwork 82, recirculation fans 84, and insulation elements 86, the unit 20 is light enough to be handled safely by a single individual. In addition, the lightweight and compact nature of the unit 20 make the unit suitable for traditional shipping methods such as UPS and FedEx, which are convenient and cost effective in comparison to the truck/van freight lines required to transport larger, heavier, and more cumbersome units. This ability to ship via traditional package shipping methods facilitates a convenient exchange program through which a customer may receive and install a new or refurbished replacement unit 20 in exchange for uninstalling and returning a malfunctioning unit 20 to the manufacturer or service provider for repair or recycle. Alternatively, because the unit 20 does not contain all of the cooling components needed for a complete refrigeration cycle, the pull-out tray 26 is not overly crowded, and therefore, the components are easily accessible for repair and/or replacement without the need to disassemble the unit 20.

The electrical control unit 34 may include or communicate with any appropriate control logic necessary to set and maintain a temperature of the cooling compartment 16. In addition, the electrical control unit 34 (or a separate module) may include or communicate with any appropriate sensors (e.g., temperature sensors, pressure sensors), sensing and/or diagnostic logic, user interfaces, and/or user displays necessary to perform system diagnostics, or to monitor, determine, and display an operational health of the merchandiser cooler 10. For example, the electrical control unit 34 may detect a faulty relay or a refrigerant leak and display that information. In another example, the electrical control unit 34 (or a separate module) may include a pressure sensing device (e.g., an electrical pressure sensor, pressure gauge, sight glass) to detect that the refrigeration system has lost its coolant charge and provide an alert that a service call is warranted. Diagnostic information of this nature may be displayed via an indicator or indicators that are visible on the front panel 21 of removable refrigeration unit 20. All electrical components used within the merchandiser cooler 10 may be so-called plug and play electrical components that may be easily replaced in the field without specialized training.

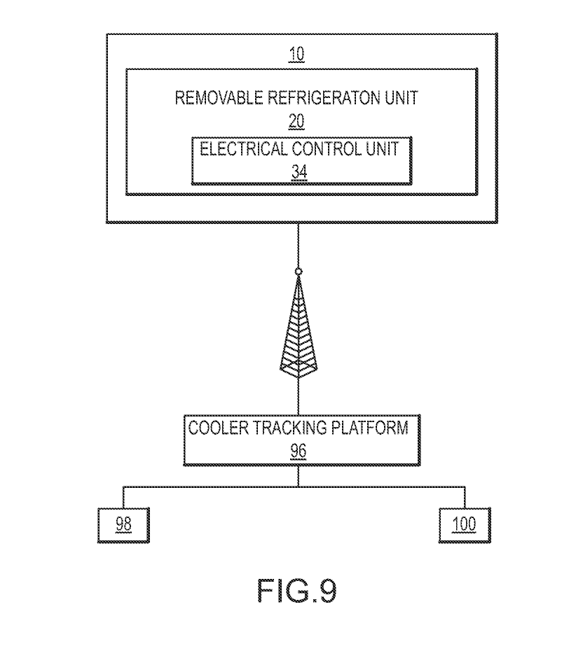

As shown in FIG. 9, the electrical control unit 34 (or a separate module) may also be communicatively linked (e.g., via a cellular telephone network) with a larger cooler tracking system or platform 96 that is operated, for example, by an owner of the cooler 10 and/or the removable refrigeration unit 20, a food and beverage service company, or the like. Through the module 34, the removable refrigeration unit 20 may broadcast identifying information such as a serial number or another coded identifier for either the merchandiser cooler 10 or the removable refrigeration unit 20 to the cooler tracking platform 96. The module 34 may also broadcast a GPS location along with diagnostic information (e.g., service needs), inventory information, and/or other operational information to parties charged with maintaining, servicing, and/or transporting the merchandiser cooler 10 and/or the removable refrigeration unit 20. Information received by the cooler tracking platform 96 may then be formatted and distributed to interested parties such as the cooler or refrigeration-unit lessee or store, repair personnel, and/or food and beverage delivery personnel. For example, the information may be delivered via email or made available through a password protected web portal such that it is accessible through any internet enabled device 98 or the information may be delivered via text message to a user's mobile phone 100.

While various embodiments of the present invention have been described in detail, it is apparent that further modifications and adaptations of the invention will occur to those skilled in the art. However, it is to be expressly understood that such modifications and adaptations are within the spirit and scope of the present invention.

What is claimed:

1. A merchandiser cooler, comprising:
a cabinet, said cabinet framing a cooling compartment;
a removable tray coupled with said cabinet; and
a plurality of cooling components for cooling said cooling compartment, said cooling components comprising insulation components for insulating said cooling compartment, ventilation components for circulating air to and from said cooling compartment, and refrigeration components for removing heat from air circulating from said cooling compartment, wherein said refrigeration components comprise a first group of refrigeration components disposed upon said removable tray and a second group of refrigeration components affixed within said cabinet.

2. A merchandiser cooler as set forth in claim 1, wherein said insulation components and said ventilation components are affixed within said cabinet.

3. A merchandiser cooler as set forth in claim 1, wherein said refrigeration components comprise a compressor, a condenser, an expansion valve, an evaporator, a condenser fan, and control electronics.

4. A merchandiser cooler as set forth in claim 3, wherein said first group of refrigeration components comprises said compressor and said condenser.

5. A merchandiser cooler as set forth in claim 3, wherein said first group of refrigeration components comprises said compressor, said condenser, said condenser fan, and said control electronics.

6. A merchandiser cooler as set forth in claim 3, wherein said second group of refrigeration components comprises said evaporator.

7. A merchandiser cooler as set forth in claim 1, wherein said insulating components comprise one or more insulation elements.

8. A merchandiser cooler as set forth in claim 1, wherein said ventilation components comprise one or more recirculation fans and one or more air ducts.

9. A merchandiser cooler as set forth in claim 1, further comprising a quick disconnect system for separating a refrigeration line that fluidly connects said first and second groups of refrigeration components.

10. A merchandiser cooler as set forth in claim 9, wherein said quick disconnect system comprises one or more fittings that couple and decouple said refrigeration line substantially without fluid loss or air intake.

11. A merchandiser cooler as set forth in claim 1, further comprising a diagnostic computer for determining and reporting an operational health of said merchandiser cooler.

12. A merchandiser cooler as set forth in claim 1, wherein said merchandiser cooler is communicatively linked with a remote cooler tracking system, and wherein said remote cooler tracking system tracks one or more of a product inventory, a location, and an operational health of said merchandiser cooler.

13. A removable refrigeration unit for a merchandiser cooler having a cabinet with affixed insulation components for insulating a cooling compartment within the cabinet and affixed ventilation components for circulating air to and from the cooling compartment within the cabinet, said removable refrigeration unit comprising:
a tray for slidably coupling with the cabinet of the merchandiser cooler; and
a first group of refrigeration components disposed upon said tray, wherein one or more of said first group of refrigeration components detachably interconnect with one or more of a second group of refrigeration components that are affixed within said cabinet such that said tray and said first group of refrigeration components are removable from said cabinet.

14. A removable refrigeration unit for a merchandiser cooler as set forth in claim 13, further comprising a fluid line that detachably interconnects said one or more of said first group of refrigeration components and said one or more of said second group of refrigeration components.

15. A removable refrigeration unit for a merchandiser cooler as set forth in claim 14, further comprising one or more connectors for detachably joining said fluid line between said first group of refrigeration components and said second group of refrigeration components.

16. A removable refrigeration unit for a merchandiser cooler as set forth in claim 15, wherein each said connector is selectively movable between connected and disconnected positions, and wherein there is substantially no fluid leakage in said fluid line in said connected position, in said disconnected position, or in transitioning between said connected and disconnected positions.

17. A removable refrigeration unit for a merchandiser cooler as set forth in claim 13, wherein said first group of refrigeration components comprises a compressor and a condenser.

18. A removable refrigeration unit for a merchandiser cooler as set forth in claim 17, wherein said first group refrigeration components further comprises a condenser fan and control electronics.

19. A removable refrigeration unit for a merchandiser cooler as set forth in claim 13, wherein said second group of refrigeration components comprises an evaporator with which the first group of refrigeration components is in fluid communication.

20. A method of replacing a removable refrigeration unit for a merchandiser cooler having a cabinet, comprising:
releasing one or more connectors that join a refrigeration line circulating fluid between first and second groups of refrigeration components configured to remove heat from air circulating from a cooling compartment of said merchandiser cooler, said first group of refrigeration components associated with said removable refrigeration unit and said second group of refrigeration components affixed within said cabinet of said merchandiser cooler; and
sliding said removable refrigeration unit from said cabinet.

21. A method of replacing a removable refrigeration unit as set forth in claim 20, wherein said first group of refrigeration components comprises a compressor and a condenser and said second group of refrigeration components comprises an evaporator.

22. A method of replacing a removable refrigeration unit as set forth in claim 20, wherein said releasing does not cause leakage of said circulating fluid.
